(19) United States
(12) Patent Application Publication
(10) Pub. No.: US 2012/0005178 A1
(43) Pub. Date: Jan. 5, 2012

(54) System and Method for Network Printing from a Peripheral Device

(76) Inventor: Jodat Jamil Gazala, Lexington, KY (US)

(21) Appl. No.: 12/828,119

(22) Filed: Jun. 30, 2010

(51) Int. Cl. G06F 17/30; G06F 3/048; G06F 7/00

(52) U.S. Cl. 707/705; 726/28; 715/739; 707/E17.005; 707/E17.032

(57) ABSTRACT

A method for processing a file on a networked peripheral device includes retrieving a file to be processed over a network and processing the retrieved file according to at least one instruction from the user. Retrieving the file includes displaying on a user interface a list of files located in a designated network path, receiving a selection from a user indicating the desired file, and receiving the selected file from a storage location associated with the designated network path. The processing of the retrieved file may include printing, faxing, e-mailing, copying, deleting or moving the selected file.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to printing devices and printing methods, and more particularly to those printing devices having network capabilities.

2. Description of the Related Art

Printing a document, image or other file or job typically occurs by a print job being pushed or sent from a user terminal, computer or other device to a printing or multi-function peripheral device having the capability to perform printing as well as copying, scanning and/or e-mailing. To accomplish this, it is well-known in the art to open the desired file within a software application and initiate printing from the within such application.

It is also known in the art to initiate printing a job at the printing device by pulling the file to be printed from a removable storage medium, such as a Universal Serial Bus (USB) storage device connected to such printing device. In such instances, the file is locally stored on the USB device, and the file is accessible only for as long as the USB device is physically connected to the printing device.

In yet other known printing devices, files which are repeatedly printed, such as forms, may be stored on the hard disk or drive of the printing device. Thus, in order to print or otherwise process files in known printing devices, a user must have access to a computer to initiate a job, the desired file must be carried around by the user or the file must be previously stored on the printing device.

However, when a user is away from a networked computer where files are stored, such as when he is away from his office, working remotely or at a location different from his normal workplace, such as at a satellite office or at an off-site location, a user may not have the desired access to the file. Further, a user may have concerns with physically carrying around or travelling with sensitive documents or files.

Thus, there is a need to have the ability to initiate the processing of a job to without having direct access to the computer on which the file is stored, previously storing the file on the printing device or carrying the file around.

### SUMMARY OF THE INVENTION

In light of the above, there is a need to have the ability to initiate the processing of a job directly from a printing device.

A first exemplary embodiment of the present invention is a method for processing a file on a networked peripheral device which includes retrieving a file to be processed over a network and processing the retrieved file according to at least one instruction from the user. Retrieving the file includes displaying on a user interface a list of files located in a designated network path, receiving a selection from a user indicating the desired file, and receiving the selected file from a storage location associated with the designated network path. 14. The processing of the retrieved file may include at least one of printing, faxing, e-mailing, copying, deleting or moving the selected file.

In one aspect of the first embodiment, the method may verify that the user is authorized to access at least one of the desired file and the designated network path. Verifying user authorization may include receiving at least one credential associated with the user and comparing the received credential to permission information associated with at least one of the designated network path and the desired file. The user credential may be extracted from a removable storage medium. The user credential may also be inputted by the user at the peripheral device. If the received credential does not match the permission information, an error message may be displayed on the user interface.

In another aspect of first embodiment, input from a user is received at the peripheral device to search the network for the file.

In still another aspect of the first embodiment, the list of files displayed on the user interface or only those files that are in a device ready format.

In yet another aspect of the first embodiment, the peripheral device instructs at least one of a server and computer to interpret the selected file and receives the interpreted selected file. Interpreting may performed by a client is installed on the computer. Interpreting may be performed by an application installed on the computer.

A second exemplary embodiment of the present invention is a method for processing a file on a networked peripheral device which includes receiving a request for access to a file stored in a designated network path and transmitting the file to the networked peripheral device for processing in accordance with at least one instruction from the user. The request for access is initiated by a user at the networked peripheral device.

In one aspect of the second embodiment, the method may verify that the user is authorized to access at least one of the desired file and the designated network path. Verifying user authorization may include receiving a credential from the user via the networked peripheral device and comparing the received credential to permission information associated with at least one of the designated network path and the desired file.

A third exemplary embodiment of the present invention is a device connected to a network capable of printing which has a computer-readable storage medium for storing code capable of instructing the device to retrieve a file to be processed from a storage location associated with a designated network path and process the retrieved file. The instructions to retrieve the file includes instructions to display to the user a list of files on a designated network path, receive a selection from a user indicating the desired file, receive the file from a storage location associated with the designated network path. The processing the retrieved file may include at least one of printing, faxing, e-mailing, copying, deleting or moving the selected file.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram of a system utilized in performing the method described in a first embodiment of the present invention.

FIG. 2 is a view of an exemplary hardware and software environment utilized in the system of FIG. 1.

FIG. 3 illustrates one embodiment of a method for processing a network file according to the present invention.

FIG. 4 is an illustration of the contents of a database utilized in performing an exemplary method according to the present invention.

FIG. 5 is an illustration of a user interface utilized in one embodiment of the present invention.

FIG. 6 is a flow chart illustrating the actions performed to retrieve a network file in the system of FIG. 1 according to one aspect of the present invention.

FIG. 7 illustrates a second embodiment of a method for processing a network file according to the present invention.

### DETAILED DESCRIPTION

Reference will now be made in detail to the exemplary embodiment(s) of the present invention, as illustrated in the accompanying drawings. Whenever possible, the same reference numerals will be used throughout the drawings to refer to the same or like parts or functions.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

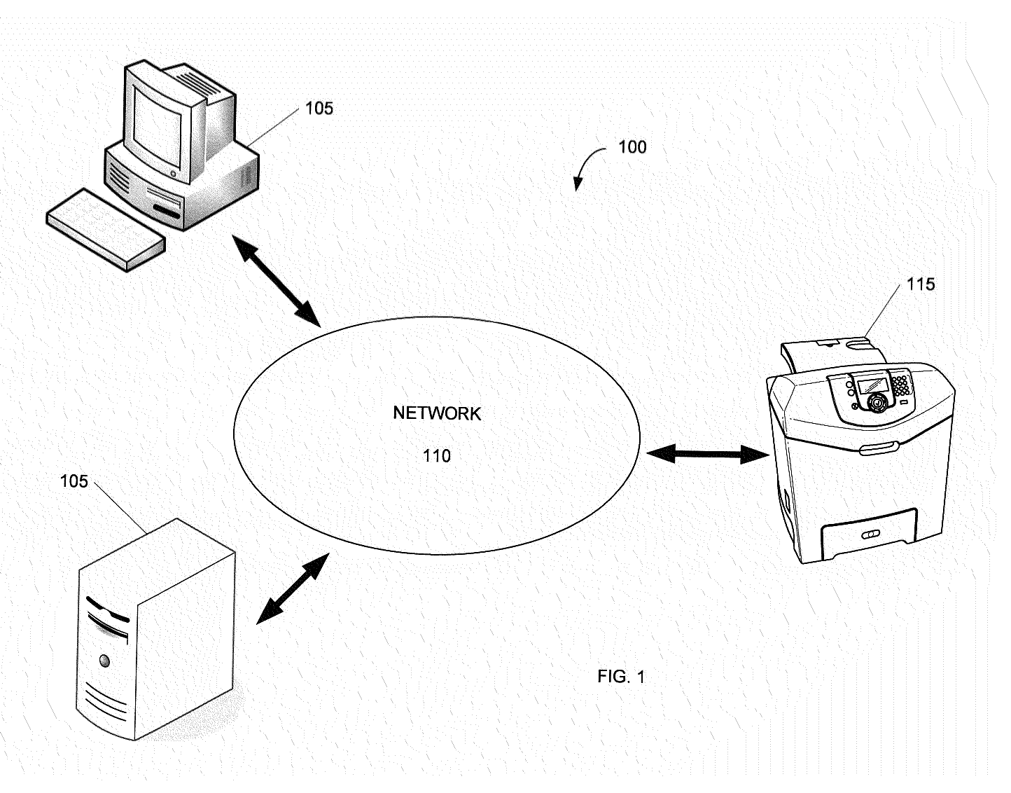

FIG. 1 is a block diagram of a first embodiment of a network printing system 100 embodying the present invention. Network printing system may include one or more computers 105 capable of communicating over a network 110 to a peripheral device 115. As used herein, the term “network” is used to generally refer to structure that facilitates electronic communication between multiple components and may operate using wired or wireless technology. Wired communication between the computer 105 and printing device 115 over a wired network may occur over a USB data link, Firewire data link, or other similar data link. Wireless communication between the computer 105 and printing device 115 may occur over Wi-Fi, WiMax, wireless USB, Bluetooth, or other similar data link.

Computer 105 may be a single computer device. Computer 105 may be, for example, a personal computer, including memory, such as RAM, ROM, and/or NVRAM, an input device, such as a keyboard, and a display monitor. Computer 105 further includes a processor, input/output (I/O) interfaces, and may include at least one mass data storage device, such as a hard drive, a CD-ROM and/or a DVD unit. The mass data storage device of computer 105 may also be divided into two or more network drives or network shares.

A monitoring agent application may be stored in computer 105. When present in computer 105, the monitoring agent application has the capability to monitor or listen to peripheral device 115 and execute instructions and/or perform certain functions in response to data received from peripheral device 115.

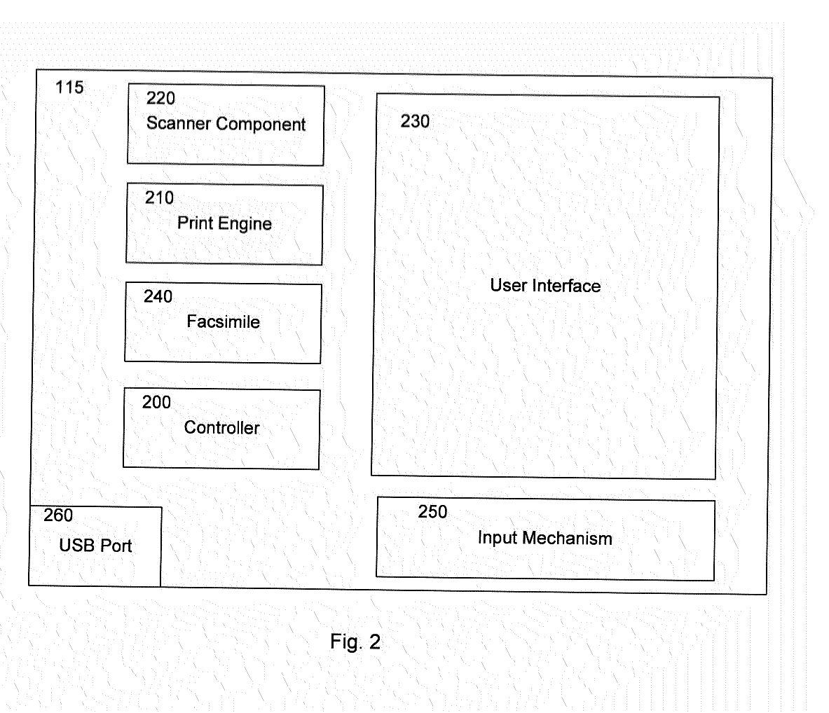

FIG. 2 shows a block diagram of peripheral device 115 as a multifunction device that includes a controller 200, a print engine 210, a scanner component 220, and a user interface 230. Peripheral device 115 may communicate with computer 105 via a standard communication protocol, such as universal serial bus (USB), Ethernet or IEEE 802.xx. A multifunction device is also sometimes referred to in the art as an all-in-one (AIO) unit or a multifunction printer (MFP). Peripheral device 115 may also have a facsimile component 240 and/or electronic mail component (not shown) for performing the functions of e-mailing and/or faxing. Those skilled in the art will recognize that peripheral device 115 may be, for example, an ink jet printer/copier; an electrophotographic printer/copier; a thermal transfer printer/copier; another mechanism including a printer, scanner, facsimile and/or e-mail component; or a standalone scanner system. In an alternate embodiment, peripheral device 115 may be a single function device such as a printer, copier, scanner or facsimile machine.

User interface 230 may be a graphical user interface, a character display, or any other output mechanism for communicating information to a user. Peripheral device 115 may also include an input mechanism 250 for receiving user commands and/or peripheral device 115 or job feature selections. Input mechanism 250 may include one or more user selectable buttons, a keyboard, a mouse or any other component for receiving user inputs. In an alternate embodiment, the user interface and input mechanism may be a single component, such as a touch screen display.

Device 115 may also include a port 260 for receiving a removable memory card or storage medium containing user information. Exemplary storage mediums may include, but are not limited to a USB thumb drive, a PictBridge card and a memory card with a reader.

Information stored on a removable storage medium may include a location identifier that indicates the location of the network path. Such information may also include the user's credentials, such as a user name and/or password, which may be required by the network in order to provide the access desired to the user.

Controller 200 includes a processor unit and associated memory and may be formed as one or more Application Specific Integrated Circuits (ASICs). Memory may be, for example, random access memory (RAM), read only memory (ROM), and/or non-volatile RAM (NVRAM). Alternatively, memory may be in the form of a separate electronic memory (e.g., RAM, ROM, and/or NVRAM), a hard drive, a CD or DVD drive, or any memory device convenient for use with controller 200. Controller 200 may be, for example, a combined printer and scanner controller.

Controller 200 may include instructions which interpret command data or user inputs and execute or carry out an action corresponding to the command data. Such instructions may be contained in firmware, a software application and/or plug-in. One such set of instructions, application or program that may be installed or resides in controller 200 of peripheral device 115 may be an application to perform network printing.

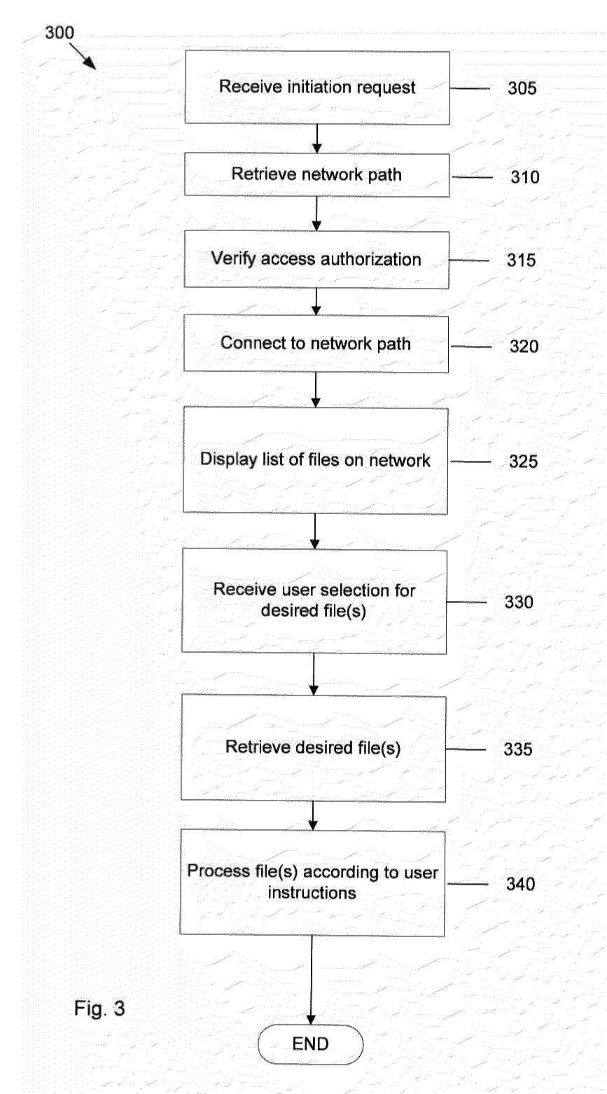

FIG. 3 illustrates a flow diagram of the process 300 of processing a file accessed over network 110 in accordance with a first embodiment of the present invention.

At block 305, a user initiates a request to access a file stored in the network. Such initiation request may occur using any number of methods. For example, in the first embodiment of the present invention, the user swipes a badge, smart card, proximity card, bar code, removable storage device or other user authentication device containing user credentials at peripheral device 115.

In an alternate embodiment, a request may be initiated after the user enters or supplies required credentials, such as a user name and/or password, at peripheral device 115. In yet another embodiment, request initiation may be a hybrid process, where some of the credentials are contained on a USB storage device and automatically extracted and other credentials require additional input from the user at peripheral device 115. For example, the network path and the user's name may be contained on the USB storage device, but peripheral device 115 prompts the user to enter the password.

In yet another alternate embodiment, a user can initiate a request by selecting the desired function to be performed via the user interface.

In still another alternate embodiment, a user can initiate a request by selecting the desired directory or file. In such embodiment, the manufacturer, information technology administrator, consultant or user may customize the user interface to display the icons or descriptions corresponding to the directories and/or files to which a user has access and/or which may be regularly used by the user or the group to which the user belongs.

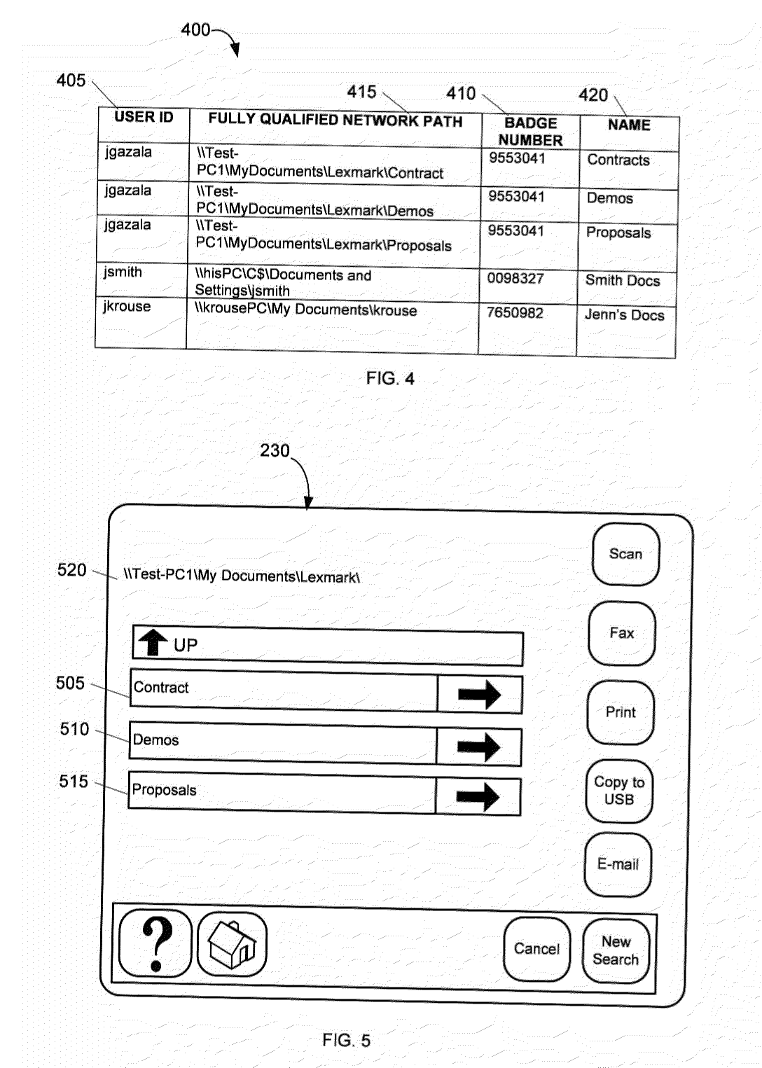

Retrieving the network path occurs at block 310. In the first embodiment of the present invention, peripheral device 115 retrieves the network path(s) associated with the user based upon the user credentials. Such network path may indicate the network share drive, directory(ies), and/or file(s) for which the user has permission to access. FIG. 4 illustrates an exemplary database 400 which contains user credentials 405 and 410 authorized network paths 415 and their associated directory short names or user-friendly names 420.

Once the network path is identified, verification of access permissions occurs at block 315. Computer 105 compares the user's credentials, such as the user name and password, to the permission settings of the network path to verify that the user's access is authorized. In an alternate embodiment, all users are automatically verified because the permission settings of the network path are preset to a guest account and may not require a password. In yet another embodiment, verification of access permissions may occur at peripheral device 115.

Once a user's access permissions have been verified, peripheral device 115 connects to the network path at block 320 and displays on user interface 230 a list of the directories and/or files on the network path which the user may access (block 325). FIG. 5 illustrates an exemplary user interface 230. userID jgazala has access to the following network paths: Contract directory 505, Demos directory 510 and Proposals directory 515 at the network path \\Test-PC1\My Documents\Lexmark\ 520.

In another embodiment, a list of all of the directories and/or files on the network path may be displayed. In yet another embodiment, the user may be prompted to search the network path for the desired directory and/or file.

After a selection indicating the desired file is received from the user (block 330), peripheral device 115 retrieves the desired file (block 340) and processes it according to instructions received from the user. Such instructions may include requests to perform at least one of the following functions: printing the file or a portion thereof, faxing the file, e-mailing the file, copying or moving the file to a removable storage medium Such instructions may also include performing functions on the file that are traditionally performed by a computer, such as copying the file to another directory on the network, and moving the file to another directory on the network or deleting the file from its storage location and off of the network.

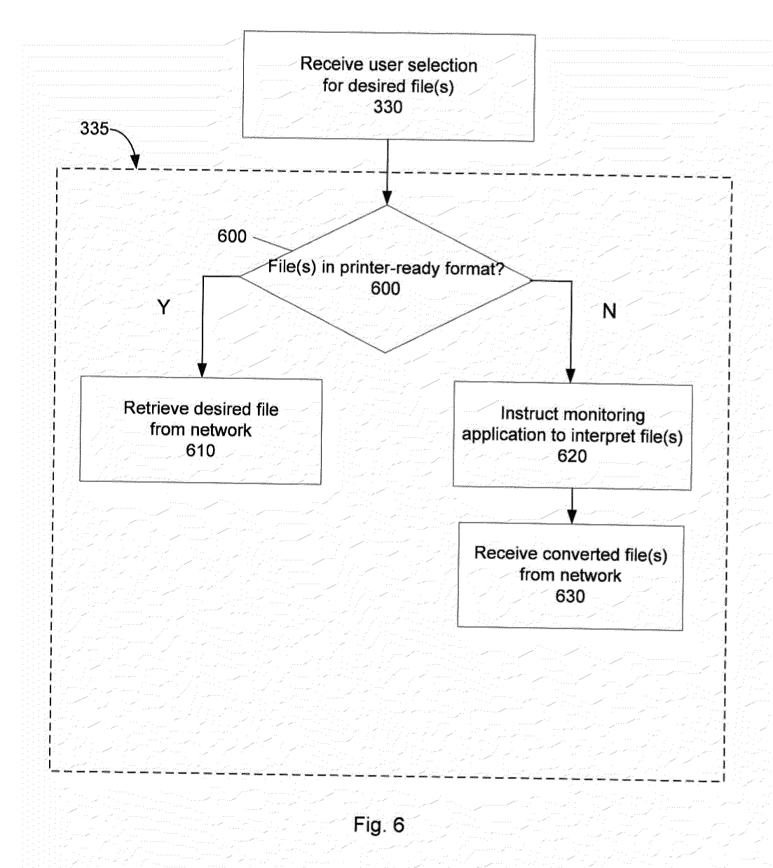

FIG. 6 illustrates a process of retrieving a file 335 according to one embodiment of the present invention. At block 600, peripheral device 115 determines whether the file is in a device or printer ready format. As used herein, “device ready format” and “printer ready format” mean that the file is in a format capable of being in printed or processed in its native form (i.e., the format is supported by peripheral device 115). Printer ready files may be processed directly by peripheral device 115 without the need for any processing by the computer on which the file is stored. Such formats may include, for example, built-in fonts, PostScript, .html, .pdf, .xps or PCL.

If the desired file is in printer ready format, peripheral device 115 retrieves the selected file from the network path over the network (block 610) for processing according to instructions received from the user. For example, if the function selected by the user is to print the file, peripheral device 115 can immediately print the file as soon as data is received over network 110 (i.e., peripheral device 115 may start printing prior to the entire print data stream being transmitted). Thus, no spooling of the file to an external print queue, such as on computer 105 is necessary, and the lack of a print queue also helps to prevent overload of a server subnet and eliminate a network bottleneck.

If the file is not in a format not readily recognized by peripheral device 115 or capable of being in processed in its native form, the peripheral device may instruct a monitoring application running on computer 105 to interpret, digest or convert the file into a format understood by peripheral device 115 at block 620.

The monitoring application may also be desirable when computer 105 is capable of performing the same function as peripheral device 115 more efficiently. For example, if the requested function is e-mailing, peripheral device 115 may retrieve the file and then e-mail it. However, it would be more efficient for peripheral device to just send the necessary information and instructions to the monitoring application so that computer 105 can e-mail the document out directly.

Once the monitoring application receives a print request from peripheral device 115, the monitoring application may process and submit the print job to peripheral device 115 using any number of known methods (block 630). In one embodiment, the monitoring application may automatically launch the software application installed on computer 105 which is associated with the format of the desired file. For example, if the desired file is in .doc format, the monitoring application may execute an instruction or series of instructions or macro which initiates an instance of Microsoft Word, submits the print job to peripheral device 115, and close such instance of Microsoft Word. Having the appropriate software installed on the computer for each file type stored on computer 105 may be advantageous in situations where printing only a select page(s) of the file is desired instead of the entire contents of the file. While this process may be visible to the user, such process may also be performed in the background without the user's knowledge or input.

In another embodiment, the monitoring application may check for a software application or a plug-in on a designated server and provide a link to the software for configuring the file into a printer ready format.

In yet another embodiment, a multi-format ripper software application which recognizes the proprietary format of the desired file, such as Stellent/Oracle Outside In Image Export, may be installed on the computer 105. In this embodiment, when the monitoring application receives the instruction to interpret, the monitoring application may automatically launch the ripper application, send the file to such application for ripping, transmit the ripped file to the peripheral device and then close such application. While this process may be visible to the user, such process may also be performed in the background without the user's knowledge or input.

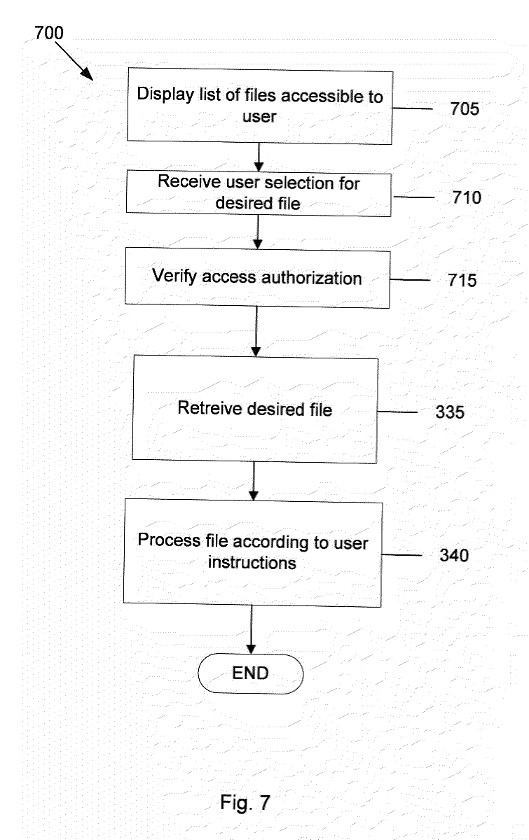

FIG. 7 illustrates a flow diagram of the process 700 of accessing a file over network 110 in accordance with a second embodiment of the present invention. In this embodiment, network paths may be preset or customized by the manufacturer, information technology administrator, consultant or user.

At block 705, user interface 230 displays the icons, descriptions or names of directories and/or files on the network path to which a user may have access and/or which may be regularly used by the user or associated with a group to which the user belongs.

After the user selects the desired directory or file from the displayed list (block 710), computer 105 verifies that the user is authorized to access such directory or file on the network path (block 715). Such verification may be automatically performed based upon credentials previously supplied by the user. Such verification may also require a user to supply or input additional credentials.

If the user is not authorized, peripheral device 115 may not display contents of the desired directory and/or not retrieve the desired file. In such instance, the device may instead indicate to the user that access has been denied and/or request the resubmission of the user's credentials (block 720). In an alternate embodiment, such verification may be performed at peripheral device 115.

If the user has the correct permissions or is otherwise authorized to access the desired directory and file, peripheral device 115 may retrieve such file (block 725). Such file retrieval may employ the same or similar process as retrieval process 335 described in the first embodiment of the present invention. Similarly, the desired file may be processed in similar fashion to the processing 340 described in connection with the first embodiment.

The foregoing description of several methods and an embodiment of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for processing a file on a networked peripheral device, comprising:
retrieving a file to be processed over a network; and
processing the retrieved file according to at least one instruction from the user, wherein the retrieving the file includes
displaying on a user interface a list of files located in a designated network path;
receiving a selection from a user indicating the desired file; and
receiving the selected file from a storage location associated with the designated network path.

2. The method of claim 1, further comprising:
verifying the user is authorized to access at least one of the desired file and the designated network path.

3. The method of claim 2, wherein the verifying user authorization comprises:
receiving at least one credential associated with the user; and
comparing the received credential to permission information associated with at least one of the designated network path and the desired file.

4. The method of claim 3, wherein the receiving the at least one credential associated with the user comprises extracting the at least one credential from a removable storage medium.

5. The method of claim 3, wherein an error message is displayed on the user interface if the received credential does not match the permission information.

6. The method of claim 1, wherein the designated network path is extracted from a removable storage medium.

7. The method of claim 1, wherein the retrieving the file further comprises receiving input from a user at the peripheral device to search the network for the file.

8. The method of claim 1, wherein the list of files comprises only files that are in device ready format.

9. The method of claim 1, wherein the receiving the selected file from the storage location comprises:
instructing at least one of a server and computer to interpret the selected file; and
receiving the interpreted selected file.

10. The method of claim 1, wherein the interpreting is performed by a client is installed on the computer.

11. The method of claim 1, wherein the interpreting is performed by an application installed on the computer.

12. The method of claim 10, wherein the application recognizes the format of the selected file.

13. The method of claim 1, wherein the retrieving the file includes presenting a preview of the selected file.

14. The method of claim 1, wherein no spooling of the selected file is required in the processing the retrieved file.

15. The method of claim 1, wherein the at least one instruction is at least one of printing, faxing, e-mailing, copying, deleting and moving the selected file.

16. The method of claim 1, wherein the displaying the list of files comprises displaying a preview of at least one page of file content.

17. A method for processing a file on a networked peripheral device, comprising:
receiving a request for access to a file stored in a designated network path, the request being initiated by a user at the networked peripheral device; and
transmitting the file to the networked peripheral device for processing in accordance with at least one instruction from the user.

18. The method of claim 16, further comprising:
verifying the user is authorized to access at least one of the desired file and the designated network path.

19. The method of claim 17, wherein the verifying user authorization comprises:
receiving a credential from the user via the networked peripheral device; and
comparing the received credential to permission information associated with at least one of the designated network path and the desired file.

20. A device capable of printing connected to a network, comprising:
a computer-readable storage medium for storing code capable of instructing the device to:
retrieve a file to be processed from a storage location associated with a designated network path; and
process the retrieved file according to an instruction by the user, wherein the instructions to retrieve the file includes instructions to:
display to the user a list of files located in a designated network path;
receive a selection from a user indicating the desired file;
receive the file from a storage location associated with the designated network path.
